(19) United States
(12) Patent Application Publication
(10) Pub. No.: US 2002/0047063 A1
(43) Pub. Date: Apr. 25, 2002

(54) Tape cartridge

(75) Inventors: Hiroshi Kaneda, Tokyo (JP); Motohiko Shima, Tokyo (JP); Akio Momoi, Tokyo (JP); Masatoshi Okamura, Tokyo (JP); Takateru Satoh, Tokyo (JP)

Correspondence Address: GREENBLUM & BERNSTEIN, P.L.C., 1941 ROLAND CLARKE PLACE, RESTON, VA, 20191, US

(73) Assignee: TDK Corp., Tokyo (JP)

(21) Appl. No.: 09/855,657

(22) Filed: May 16, 2001

(30) Foreign Application Priority Data
May 19, 2000 (JP) 2000-147957
May 14, 2001 (JP) 2001-142500

(51) Int. Cl. G11B 23/107

(52) U.S. Cl. 242/348

(57) ABSTRACT

A tape cartridge includes a cartridge body which is formed by cartridge halves 211 and 212, and has peripheral walls formed by respective side walls 221b and 212b of the cartridge halves 211 and 212, and a tape reel. The tape cartridge is configured such that one of the peripheral walls of the cartridge body has a corner portion formed with a tape extraction hole, and that a side wall 212b of a cartridge half 212 and a side wall 211b of a cartridge half 211 forming another peripheral wall adjacent to the corner portion have end surfaces thereof brought into contact with each other. The side wall 211b is coupled to the side wall 212b in a state in which the movement of the end surface of the side wall 211b in a direction away from the end surface of the side wall 212b and the respective movements of the side wall 211b to the outer surface side and inner surface side thereof are restricted.

### BACKGROUND OF THE INVENTION

1. Field of the Invention

This invention relates to a tape cartridge having a tape reel rotatably received within a body of the tape cartridge, with a magnetic tape wound around the tape reel.

2. Description of the Related Art

A single-reel type tape cartridge was proposed in Japanese Laid-Open Patent Publication (Kokai) No. 11-339436, which incorporates a memory device, such as an IC memory or the like, capable of reading or writing information stored in a magnetic recording tape. Portions of upper and lower casings (a pair of casings) of the proposed tape cartridge in the vicinity of the memory device is secured to each other by a screw formed of a non-magnetic material so as to avoid electromagnetic effects on the memory device. Portions of the casings which are remote from the memory device and close to three corners of the cartridge are secured to each other by screws formed of magnetic or non-magnetic materials. Further, a set screw cannot be used at a corner formed with an opening portion (also referred to as a “tape extraction hole”) for allowing the magnetic tape to be drawn out and rewound in therefrom, since the set screw will offer an obstruction in the path of the magnetic tape, and therefore portions of the casings shifted from this corner toward another corner opposite thereto are secured to each other by a screw.

More specifically, as shown in FIG. 35, in the conventional tape cartridge described in the above publication, the upper and lower casings are secured to each other at four locations formed with screw bosses 27 by using self-tapping screws, and one of the screw 27 in the vicinity of the memory device 100 is made of a non-magnetic material. One corner of the upper and lower casings is formed with an opening 22 as the opening portion for allowing the tape to be drawn out therefrom, such that the opening 22 divides side walls of the casings. Therefore, a screw boss 27 is formed at a location shifted away from this corner portion toward another corner portion, to avoid the opening 22.

Further, Japanese Laid-Open Patent Publication (Kokai) No. 2000-231773 discloses a magnetic tape cartridge (also simply referred to as the “tape cartridge”) (1). This tape cartridge (1) includes a cartridge casing (4) comprised of an upper casing (2) and a lower casing (3) fastened to each other by screws, and a single reel rotatably received within the cartridge casing (4). The single reel is wound with a roll of a magnetic tape (6) which has a leader pin (5), as a magnetic tape extraction member, fixed to a leading end thereof.

One of the peripherals walls of this cartridge casing (4) is formed with an opening portion (10) for allowing the magnetic tape (6) to be drawn out. The opening portion (10) is opened and closed by a slide door (11) which is urged in a closing direction. Further, in the tape cartridge (1), when it is not used, the magnetic tape (6) is completely drawn in to be rewound around the reel, and at the same time the leader pin (5) at the leading end of the magnetic tape (6) is engaged with concave holder portions (20) formed in inner surfaces of the upper and lower casings (2, 3) at locations close to the opening portion (10). Further, in the vicinity of the opening portion (10) of the cartridge casing (4), an elastic pawl (14) protrudes downward from an inner surface of a side wall (2a) of the upper casing (2), and an engaging recess (15) is formed in a side wall (3a) of the lower casing (3), which is brought into contact with the side wall (2a). When the upper casing (2) and the lower casing (3) are combined, the above configuration causes the elastic pawl (14) to be engaged with the engaging recess (15). As a result, the upper casing (2) and the lower casing (3) are secured to each other, thereby enhancing rigidity of a portion of the cartridge casing (4) in the vicinity of the opening portion (10).

However, the two conventional tape cartridges described above suffer from the following problems: In the case of the former tape cartridge, to avoid the opening portion, portions of the upper and lower casings at a location shifted from the one corner portion formed with the opening portion toward another corner portion are secured to each other by the screw. Further, due to the presence of the opening 22, the side walls of the upper and lower casings are divided. Therefore, the strength of the one corner portion formed with the opening 22 is decreased, and a shock or impact caused by a fall of the tape cartridge can displace the side walls of the upper and lower casings from each other. Further, it can be contemplated to configure the tape cartridge, for instance, such that all the side walls of the upper and lower casings are welded by ultrasonic welding without using any screws. In this case, however, the portions of the upper and lower side walls forming one corner portion including the memory device are also welded by ultrasonic welding. Therefore, ultrasonic vibration generated for the ultrasonic welding produces resonance, which increases vibration of the memory element as a precision part. This can destroy the memory element (particularly, wire bonding and the like thereof).

On the other hand, the latter tape cartridge (1) has the following problems: Although this tape cartridge is configured such that the elastic pawl (14) of the upper casing (2) is engaged with the engaging recess (15) of the lower casing (3) to thereby prevent mutual separation of the upper casing (2) and the lower casing (3), outward movement of the side wall (3a) of the lower casing (3) with respect to the side wall (2a) of the upper casing (2) is not restricted. Therefore, when a force is applied to the side wall (3a) of the lower casing (3) such that the side wall (3a) is moved or deformed toward the outer surface side, only the side wall (3a) of the lower casing (3) is moved outward to be displaced from the side wall (2a) of the upper casing (2), which causes disengagement of the elastic pawl (14) from the engaging recess (15). When there occurs the disengagement, if a force for causing the mutual separation is simultaneously applied to the upper and lower casings (2, 3), the upper casing (2) and the lower casing (3) can be separated from each other. Therefore, the conventional tape cartridge (1) has the problem that the mutual separation of the upper and lower housings (2,3) may cause the leader pin (5) to come off the holder portions (20), which hinders the magnetic tape form being normally extracted.

### SUMMARY OF THE INVENTION

It is a main object of the invention to provide a tape cartridge which is capable of reliably preventing a mutual separation of a pair of cartridge halves even if an external force is applied to the tape cartridge.

(1) To attain the above object, the present invention provides a tape cartridge including a cartridge body which has a pair of cartridge halves combined with each other to form a shape of a box, the pair of cartridge halves having side walls forming peripheral walls of the cartridge body, and a tape reel received within the cartridge body with a roll of a tape wound therearound, the tape cartridge being configured such that a tape extraction hole is formed in a corner portion of one of the peripheral walls of the cartridge body, and that a first side wall of one of the cartridge halves and a second side wall of another of the cartridge halves forming another of the peripheral walls adjacent to the corner portion have respective end surfaces thereof brought into contact with each other, characterized in that the second side wall is coupled to the first side wall in a state in which movement of the end surface of the second side wall in a direction away from the end surface of the first side wall and respective movements of the second side wall toward an outer surface side and an inner surface side thereof are restricted.

According to this tape cartridge, the second side wall is coupled to the first side wall in a state in which movement of the end surface of the second side wall in a direction away from the end surface of the first side wall and respective movements of the second side wall toward an outer surface side and an inner surface side thereof are restricted, whereby it is possible to maintain the firm engagement of the cartridge halves. Therefore, even if an external force, such as a shock or impact, is applied to the tape cartridge, a mutual separation of the cartridge halves can be avoided, whereby it is possible to positively prevent a pin member held between the cartridge halves at a location facing the tape extraction hole from being disengaged from the cartridge halves. This makes it possible to ensure that a magnetic tape is positively drawn out, thereby enhancing the reliability of the tape cartridge.

(2) It is preferred in the above invention that the tape cartridge includes an engaging piece which is arranged on an inner surface side of a portion of the another of the peripheral walls, the portion being close to the tape extraction hole, with one end thereof being rigidly fixed to the one of the cartridge halves, and at the same time with another end thereof extending toward the another of the cartridge halves for engagement with the second side wall, and the second side wall is restricted from moving toward the outer surface side thereof by the first side wall.

According to this tape cartridge, the second side wall being restricted from moving toward the outer surface side thereof by the first side wall, and at the same time both of the cartridge halves are connected to each other by the engaging piece, whereby it is possible to maintain firm engagement of the cartridge halves, and open the cartridge halves to remove the tape reel therefrom as required.

(3) It is preferred in the above invention that the end surface of the first side wall is formed into a stepped shape in which an outer portion thereof protrudes, the end surface of the second side wall being formed into a stepped shape in which an inner portion thereof protrudes.

According to this tape cartridge, the end surface of the first side wall of the one cartridge half is formed into a stepped shape in which an outer portion thereof protrudes, and at the same time the end surface of the second side wall of the other cartridge half is formed into a stepped shape in which an inner portion thereof protrudes. This makes it possible to restrict the movement of the second side wall toward the outer surface side thereof by using the first side wall and at the same time reliably restrict the movement of the first side wall toward the outer surface side thereof by using the second side wall. Further, when the tape cartridge is to be disassembled, by taking the other peripheral wall as a fulcrum, the cartridge halves are caused to be mutually separated on the side of still another peripheral wall of the cartridge body opposed to the other peripheral wall, whereby the engaging piece and the second side wall of the another cartridge half can be automatically disengaged from each other. This makes it possible to disassemble the tape cartridge with ease.

(4) It is preferred in the above invention that the engaging piece is formed of a metal plate material.

According to this tape cartridge, the engaging piece is formed of a metal plate material, whereby it is possible to form the engaging piece into a thin member, while securing rigidity thereof. This makes it possible to increase the space of the tape extraction portion of the cartridge body via which a magnetic tape is drawn, and hence allows a magnetic tape to be smoothly drawn out from the tape extraction hole

(5) It is preferred in the above invention that the engaging piece is integrally formed with the one of the cartridge halves by resin molding.

According to this tape cartridge, the engaging piece is integrally formed with the one of the cartridge halves by resin molding, whereby the number of component parts of the tape cartridge can be reduced, and a process for assembling the engaging piece to the one of the cartridge halves can be omitted. As a result, the manufacturing costs of the tape cartridge can be reduced.

(6) It is preferred in the above invention that the first side wall and the second side wall are coupled to each other by being secured by welding at least respective portions of the end surfaces thereof in the vicinity of the tape extraction hole

According to this tape cartridge, the first side wall and the second side wall are coupled to each other by being secured by welding at least respective portions of the end surfaces thereof, whereby the upper and lower cartridge halves can be simplified in construction. This also makes it possible to simplify the structures of molds for molding the cartridge halves, so that the manufacturing costs of the tape cartridge can be reduced. Further, it is possible to maximize the space of the tape extraction portion of the cartridge body, thereby allowing a magnetic tape to be smoothly drawn out from the tape extraction hole.

(7) It is preferred in the above invention that the tape cartridge includes an engaging piece which is located on the inner surface side of the another of the peripheral walls in the vicinity of the tape extraction hole, and erected from the first side wall along an inner wall surface of the second side wall, and the end surface of the first side wall being formed into a stepped shape in which an outer portion thereof protrudes, the end surface of the second side wall being formed into a stepped shape in which an inner portion thereof protrudes, the first side wall and the second side wall being coupled to each other by being secured by welding at least respective portions of the end surfaces thereof in the vicinity of the tape extraction hole.

According to this tape cartridge the tape cartridge includes an engaging piece which is located on the inner surface side of the another of the peripheral walls in the vicinity of the tape extraction hole, and erected from the first side wall along an inner wall surface of the second side wall, and the end surface of the first side wall being formed into a stepped shape in which an outer portion thereof protrudes, the end surface of the second side wall being formed into a stepped shape in which an inner portion thereof protrudes, the first side wall and the second side wall being coupled to each other by being secured by welding at least respective portions of the end surfaces thereof in the vicinity of the tape extraction hole. Accordingly, it is possible to prevent a squeezed portion of a resin melted by application of ultrasonic waves or scrapings produced by vibration from entering the inside of the tape cartridge, thereby sufficiently preventing the surface of a magnetic tape from being scratched or the scrapings from adhering to the surface of the magnetic tape. Further, although simple in construction, by welding together at least respective portions of the end surfaces formed into stepped shapes, the side walls are fitted on each other in a recess/protrusion form with no gaps therebetween. This makes it possible to reliably restrict the movements of the side walls in directions of mutual separation, and at the same time restrict the outward and inward movements and deformation of the second side wall with respect to the first side wall as well as restrict the outward or inward movements and deformation of the first side wall with respect to the second side wall.

(8) To attain the above object, the present invention provides a tape cartridge including a cartridge body formed by a pair of square cartridge halves, and a tape reel rotatably received within the cartridge body, with a roll of a tape wound therearound, wherein a memory element is provided in a corner portion of the cartridge body outside a tape reel area thereof, one corner portion of the cartridge body other than the corner portion having the memory element provided therein being formed with a tape extraction hole for allowing the tape to be extracted out of the cartridge body, characterized in that the pair of cartridge halves are fastened by screws outside the tape reel area, and at the same time the one corner portion formed with the tape extraction hole is fastened by a method other than screwing.

According to this tape cartridge, a pair of cartridge halves are configured such that the pair of cartridge halves are fastened by screws outside the tape reel area, and the one corner portion formed with the tape extraction hole is fastened by a method other than screwing. Therefore, the pair of cartridge halves can be firmly secured to each other while preventing an obstruction from being provided for the drawing out and rewinding of a tape, which contributes to sufficiently increasing the reliability of the tape cartridge.

(9) It is preferred in the above invention that the corner portion formed with the tape extraction hole is secured by welding to thereby secure the pair of cartridge halves to each other.

According to this tape cartridge, since the corner portion formed with the tape extraction hole is secured by welding, it is possible to maximize the space of the tape extraction portion while firmly securing the upper and lower casings to each other. This makes it possible to smoothly draw out a tape while sufficiently increasing the reliability of the tape cartridge.

(10) It is preferred in the above invention that the corner portion formed with the tape extraction hole is secured by a hook formed in the one of the cartridge halves and a recess formed in the another of the cartridge halves in a manner corresponding to the hook.

According to this tape cartridge, the corner portion formed with the tape extraction hole is firmly secured by a hook formed in the one of the cartridge halves and a recess formed in the another of the cartridge halves in a manner corresponding to the hook. This makes it possible to firmly secure the upper and lower casings to each other, and open the pair of cartridge halves to remove the tape reel therefrom as required.

It should be noted that the disclosure of the present specification relates to the subjects included in Japanese Patent Application No. 2000-147957 which was filed on May 19, 2000, and Japanese Patent Application No. 2001-142500 which was filed on May 14, 2001, and all of the disclosures thereby are expressly incorporated herein by reference.

### BRIEF DESCRIPTION OF THE DRAWINGS

These and other objects and features of the present invention will be explained in more detail below with reference to the attached drawings, wherein:

FIG. 1 is an exploded perspective view of a tape cartridge according to a first embodiment of the invention;

FIG. 2 is a perspective view of the tape cartridge according to the first embodiment;

FIG. 3 is a plan view of a lower casing 2 (with a memory element 100 incorporated therein) of the tape cartridge according to the first embodiment;

FIG. 4 is a sectional view taken on line A-A of a portion of the memory element 100 in FIG. 3;

FIG. 5 is an enlarged plan view of a portion enclosed by a circle in FIG. 3;

FIG. 6 is a sectional view taken on line B-B of FIG. 5;

FIG. 7 is a plan view of an upper casing 1 of the tape cartridge according to the first embodiment, as viewed from an inner side thereof;

FIG. 8 is a plan view of a lower casing 2 of a tape cartridge according to a second embodiment of the invention;

FIG. 9 is an enlarged plan view of a portion enclosed by a circle in FIG. 8;

FIG. 10 is a sectional view taken on line C-C of FIG. 9;

FIG. 11 is a plan view of an upper casing 1 of the tape cartridge according to the second embodiment, as viewed from an inner side thereof;

FIG. 12 is an enlarged plan view of a portion enclosed by a circle in FIG. 11;

FIG. 13 is an enlarged view of the FIG. 12 portion as viewed from a left side thereof;

FIG. 14 is an exploded perspective view of a tape cartridge 201 according to a third embodiment of the invention;

FIG. 15 is a perspective view of the tape cartridge 201;

FIG. 16 is a perspective view of an upper casing 211 as viewed from an inner side of a main wall W;

FIG. 17 is a perspective view of a lower casing 212 as viewed from an inner side of a main wall X;

FIG. 18 is an enlarged perspective view of a portion of the lower casing 212, where an engaging piece 215 is mounted;

FIG. 19 is a perspective view of the engaging piece 215;

FIG. 20 is a cross-sectional view of essential elements of a structure connecting side walls 211b and 212b to each other by the engaging piece 215, which is useful in explaining the structure;

FIG. 21 is a perspective view of an engaging piece 242 for a tape cartridge 241 according to a fourth embodiment of the invention;

FIG. 22 is a cross-sectional view of essential elements of a structure connecting side walls 211b and 212b to each other by the engaging piece 242 of the tape cartridge 241 according to the fourth embodiment of the invention, which is useful in explaining the structure;

FIG. 23 is an enlarged perspective view of a portion of a lower casing 252 of a tape cartridge 251 according to a fifth embodiment of the invention, the portion being formed with an engaging piece 253;

FIG. 24 is a sectional view taken on line D-D of FIG. 23;

FIG. 25 is a sectional view taken on line E-E of FIG. 23;

FIG. 26 is a plan view of essential elements of an upper casing 271 of a tape cartridge 261 according to a sixth embodiment of the invention, in the vicinity of a tape extraction hole 202c;

FIG. 27 is a side view of the FIG. 26 upper casing 271 as viewed from the side of a side wall 271b;

FIG. 28 is a sectional view taken on line F-F of FIG. 26;

FIG. 29 is a sectional view taken on line G-G of FIG. 26;

FIG. 30 is an enlarged sectional view of a protruding portion Y of FIG. 28;

FIG. 31 is a plan view of essential elements of a lower casing 272 of the tape cartridge 261 according to the sixth embodiment of the invention, in the vicinity of the tape extraction hole 202c;

FIG. 32 is a side view of the FIG. 31 lower casing 272 as viewed from the side of a side wall 272b;

FIG. 33 is a sectional view taken on line H-H of FIG. 31;

FIG. 34 is a cross-sectional view of essential elements of the tape cartridge 261, which is useful in explaining a state of the side wall 271b and the side wall 272b being fitted in a recess/projection form; and

FIG. 35 is a plan view of a lower casing of a tape cartridge according to the prior art.

### DESCRIPTION OF THE PREFERRED EMBODIMENTS

The invention will now be described in detail with reference to drawings showing preferred embodiments thereof.

(First Embodiment)

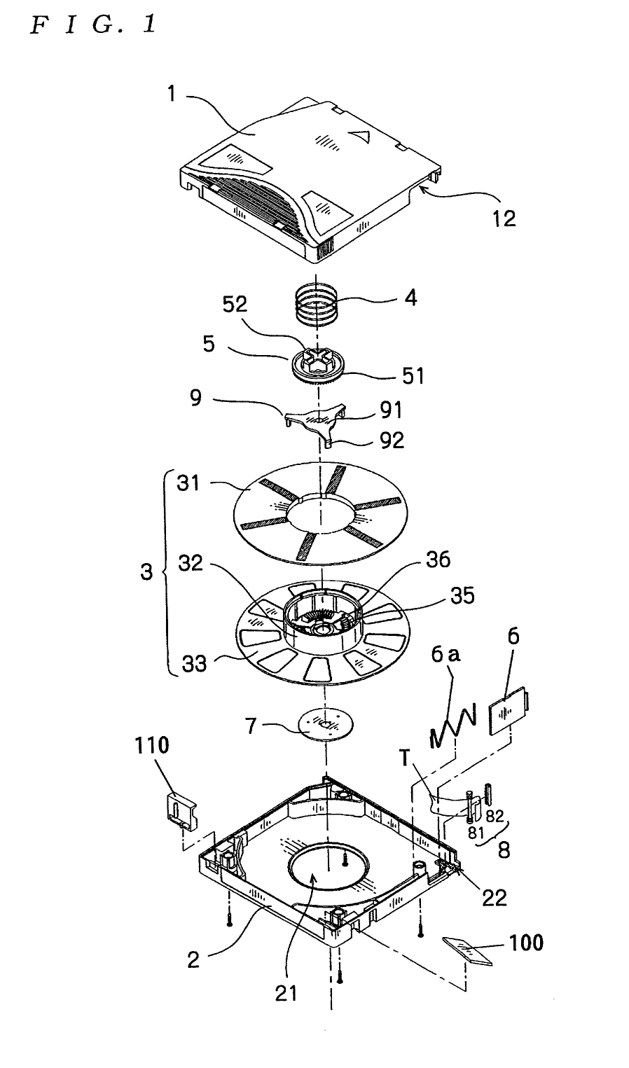

FIG. 1 is an exploded perspective view of a single-reel type tape cartridge according to a first embodiment of the invention. The cartridge has a casing body (cartridge body) formed by an upper and a lower casings (a pair of square cartridge halves) 1 and 2, and a tape reel rotatably received within the casing body, with a tape, not shown, wound therearound. The lower casing has an opening 21 for allowing a drive shaft of an apparatus to be inserted therein. The upper and lower casings 1 and 2 are formed with openings 12 and 22 which form a tape extraction hall for allowing the tape to be extracted therefrom.

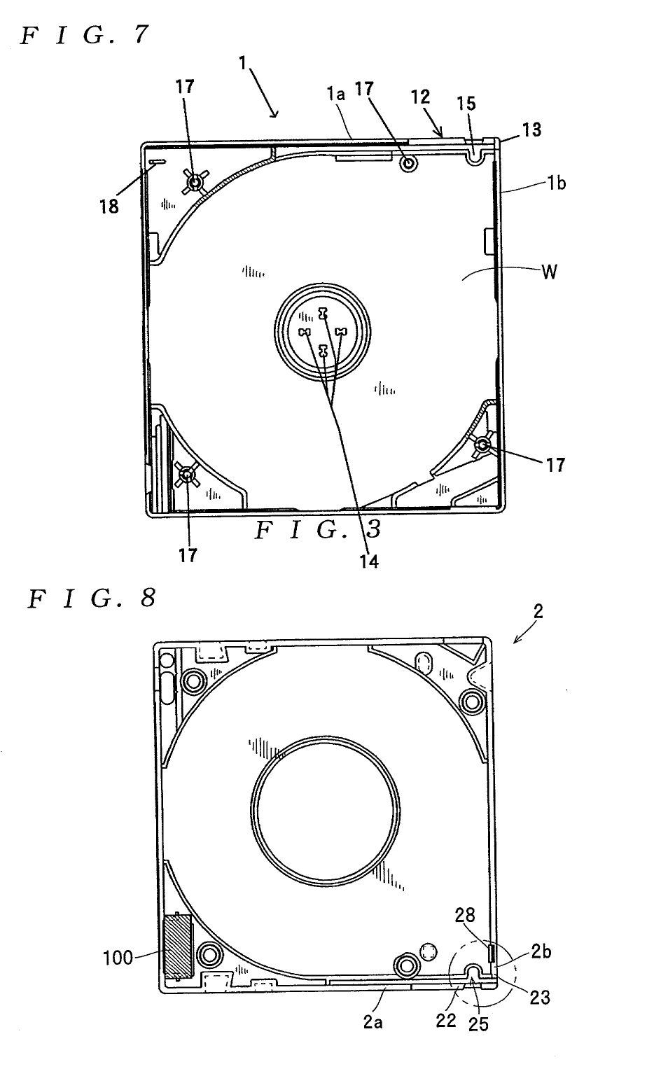

The tape reel 3 is comprised of an upper flange 31, a hub 32 integrally formed with a lower flange 33, and a metal plate 7 arranged on an underside surface of the hub 32, all of the upper flange 31, the hub 32 and the metal plate 7 forming a unitary member. The underside surface of the hub 32 has a portion around the metal plate 7, which is integrally formed with engagement teeth, not shown, for engagement with the drive shaft of the system. The metal plate 7 is formed of a soft magnetic material such that the same is magnetically attracted to the drive shaft of the apparatus to thereby rotate the tape reel 3 by the engagement teeth. The tape (also referred to as the “magnetic tape”) T is directly bonded to the outer peripheral surface of the hub 32 by alcohol or water, and therefore there is not provided a fixing member for fixing the tape T to the hub 32. The hub 32 has an inner surface thereof formed with an engagement teeth portion 35 for engagement with a reel brake (also referred to as a “lock member”) 5, thereby preventing an unnecessary rotation of the tape reel 3 when the tape cartridge is not in use. The reel brake 5 has an engagement teeth portion 51 on an underside thereof, for engagement with the engagement teeth 35 of the hub 32. The reel brake 5 is always urged toward a brake-applied position by a brake spring (also referred to as a “spring”) 4. The reel brake 5 has protrusions 52 which are guided by respective position control elements 14 (see FIG. 7) arranged on an inner wall of the upper casing 1 such that the reel brake 5 can be reliably moved in a vertical direction (between the brake-applied position and a brake-released position). A brake release plate 9 which is comprised of a main plate 91 and legs 92 is interposed between the hub 32 and the reel brake 5. In this embodiment, the legs 92 extend into respective holes 36 formed in the bottom of the hub 32. When the cartridge 1 is mounted in a record/playback apparatus, the legs 92 of the brake release plate 9 are lifted upward, whereby the reel brake 5 is lifted upward for disengagement from the tape reel 3, which permits the tape reel 3 to rotate.

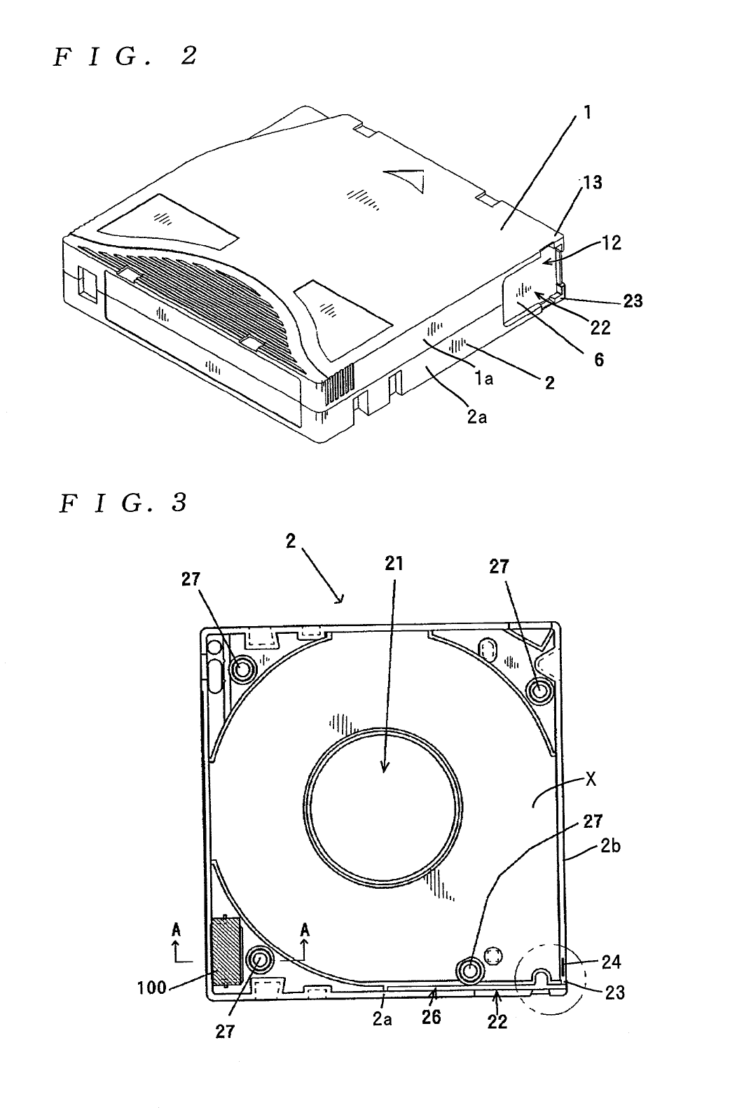

The tape T is comprised of a magnetic tape as a body tape, and a leader tape connected to a leading end of the magnetic tape (hereinafter, the magnetic tape and the leader tape are collectively referred to as the “magnetic tape”). A leader member 8 is fixed to a leading end of the tape T (leading end of the leader tape). The tape T has its leader member 8 held by a holding member, not shown, of the record/playback apparatus to thereby allow the tape to be drawn out of the casing. The leader member 8 is comprised of a pin member 81 and a C-shaped cramp 82 made of resin (also referred to as a “stopper”) . The tape T is wound around the pin member 81, and the C-shaped cramp 82 is fitted on the pin member 81 wound with the tape T, whereby the tape T is fixed. The leader member 8 is drawn out from the openings 12 and 22 of the cartridge. The casing body has a slide door (also referred to as a “shutter member”) 6 for closing the openings 12 and 22 when the cartridge is not used. This slide door 6 is urged toward its closed position by a spring 6a. As shown in FIG. 1, a safety lug 110 is arranged at one corner portion of the casing body other than the corner portion formed with the openings 12 and 22, and further, as shown in FIG. 3, a memory element 100 is arranged at still another corner portion of the casing body.

FIG. 2 is a perspective view of the tape cartridge. The figure shows a state of the slide door 6 being closed. Further, at the corner portions 13 and 23 of the upper and lower casings 1 and 2 where the openings 12 and 22 are formed, side walls are divided. More specifically, the upper casing 1 has the opening 12 formed in one side wall 1a of a pair of side walls which are to be connected to each other at the corner portion 13. The opening 12 is formed such that it extends to the other side wall 1b (see FIG. 7) as a second side wall. Therefore, the side wall 1a and the side wall 1b are divided from each other at the corner portion 13. Further, the lower casing 2 has the opening 22 formed in one side wall 2a of a pair of side walls which are to be connected to each other at the corner portion 23. The opening 22 is formed such that it reaches the other side wall 2b (see FIG. 3) as a first side wall. Therefore, the side wall 2a and the side wall 2b are divided from each other at the corner portion 23.

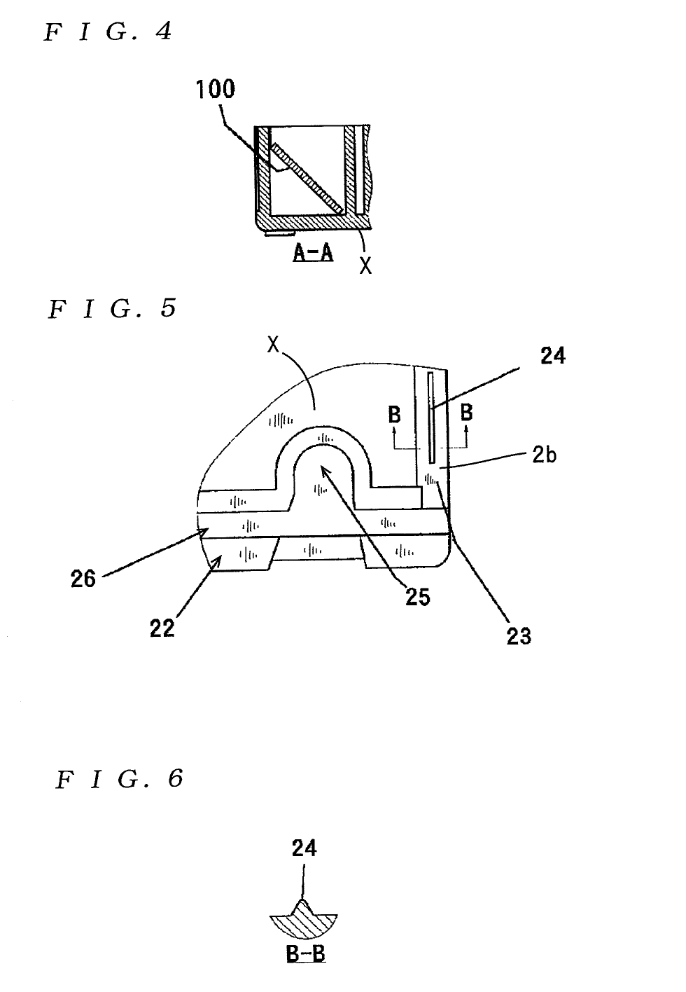

FIG. 3 is a plan view of the lower casing 2 with the memory element 100 incorporated therein. FIG. 4 is a sectional view taken on line A-A of the portion of the memory element 100 in FIG. 3. Further, FIG. 5 is an enlarged plan view of a portion enclosed by a circle in FIG. 3. Furthermore, FIG. 6 is a sectional view taken on line B-B of FIG. 5. As shown in FIGS. 3 and 4, the memory element 100 is set in a corner portion adjacent to the corner portion 23 formed with the opening 22, in a manner inclined at 45 angles with respect to a bottom wall (also referred to as a “main wall”) X of the lower casing 2. The lower casing 2 has four corner portions formed with screwing bosses 27. As shown in FIG. 3, the boss 27 provided at the corner portion 23 formed with the opening 22 is arranged at a location avoiding the opening 22. Further, as shown in FIG. 5, a U-shaped holder portion (also referred to as a “holder portion”) 25 for receiving the pin member 81 therein is formed in the main wall X of the lower casing 2 at a location behind the opening 22. Immediately before the holder portion 25, there is formed a guide groove 26 for the slide door 6.

Out of the pair of side walls 2a and 2b forming the corner portion 23 formed with the opening 22, the side wall (right-side wall in FIG. 3) 2b without the opening 22 has an upper end surface thereof formed with a welding rib 24, as shown in FIGS. 3 and 5, which is triangular in cross section. The welding rib 24 is provided so as to reinforce the corner portion 23 having no screwing boss 27 formed therewith. More specifically, after the upper and lower casings 1 and 2 have been united (combined), the welding rib 24 is melted by an ultrasonic welding process such that it is integrally fused with the upper casing 1. This makes it possible to weld the side wall 1b of the upper casing 1 and the side wall 2b of the lower casing 2 with each other at the corner portions 13 and 23, thereby reinforcing the corner portions 13 and 23 of the upper and lower casings 1 and 2 without the boss 27.

FIG. 7 is a plan view of the upper casing 1. Bosses 17 and a leader member holder portion 15 are arranged in a main wall W in a manner corresponding to the respective associated portions of the lower casing 2. Further, the main wall W is formed with a rib 18 at a corner portion of the upper casing 1 for housing the memory element 100. The rib 18 holds down the memory element 100 from above when the upper casing 1 is put on the lower casing 2. Furthermore, as clearly shown in FIG. 3, the upper and lower casings 1 and 2 have the boss 17 and the boss 27 fastened by a screw on the side of respective one end portions of the openings 12 and 22, and have the side walls 1b and 2b welded to each other by the welding rib 24 on the side of respective other end portions (on the side of the corner portions 13 and 23) of the openings 12 and 22, whereby it is possible to secure the strength of the portions where the side walls 1a and 2a are divided from each other.

Further, since the welding rib 24 is arranged only at a location remote from the memory element 100, it is possible to prevent ultrasonic vibrations for melting the welding rib 4 from adversely affecting the memory element 100. Although in the present embodiment, description is given of the example in which the welding rib 24 is arranged on the lower casing 2, this is not limitative, but the upper casing 1 may be formed with the welding rib 24 while the lower casing being formed to be planar, or alternatively the welding rib 24 may be divided to be arranged on both of the upper and lower casings 1 and 2.

(Second Embodiment)

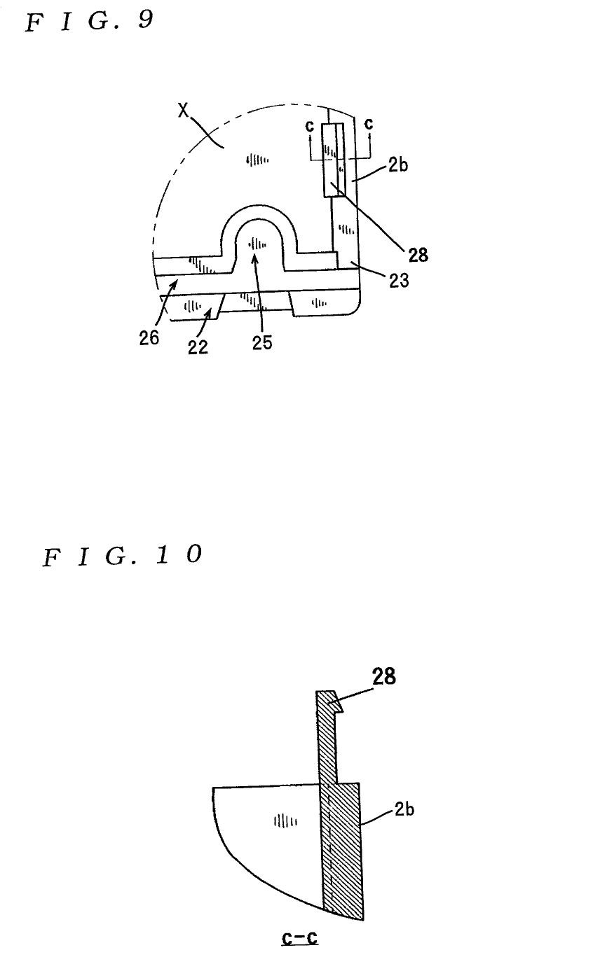

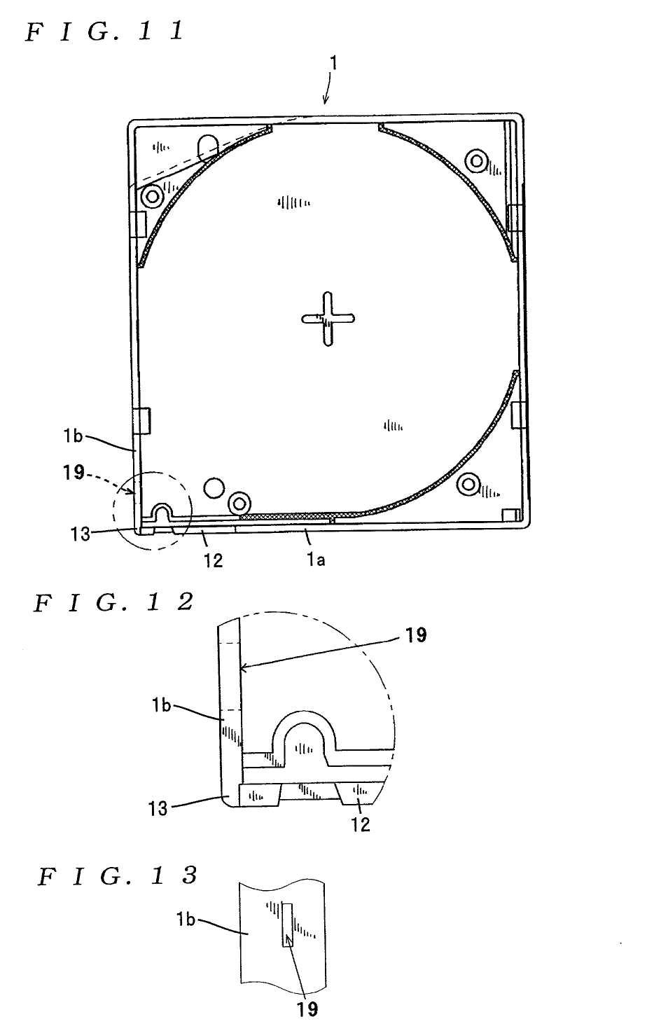

FIG. 8 is a plan view of a lower casing 2 of a tape cartridge according to a second embodiment. FIG. 9 is an enlarged plan view of a portion enclosed by a circle in FIG. 8. FIG. 10 is a sectional view taken on line C-C of FIG. 9. Further, FIG. 11 is a plan view of an upper casing 1 of the tape cartridge according to the second embodiment as viewed from an inner side thereof. FIG. 12 is an enlarged plan view of a portion enclosed by a circle in FIG. 11. FIG. 13 is a enlarged view of the FIG. 12 portion as viewed from the left.

The tape cartridge according to the present embodiment is constructed similarly to the tape cartridge according to the first embodiment with the exception of the fixing members for rigidly fixing the upper and lower casings 1 and 2, so that in the following description of the present embodiment, component parts and elements similar to those of the tape cartridge according to the first embodiment are designated by identical reference numerals, and detailed description thereof is omitted. In the tape cartridge according to the present embodiment, the end portions of side walls 1b and 2b of the upper and lower casings 1 and 2 which define the openings 12 and 22 are secured not by welding but by a combination of a hook 28 arranged on the lower casing 2 and a hole 19 formed in the upper casing 1 for engagement with the hook 28. According to this tape cartridge, corner portions formed with the openings 12 and 22 are secured to each other simply by fitting the lower casing 2 over the upper casing 1, and hence it is possible to omit a welding process, thereby reducing manufacturing costs of the tape cartridge.

Although in this embodiment, description is given of an example in which the hole 19 is formed as a through hole, this is not limitative, but the hole 19 may be formed as an indented portion so long as it is deep enough to catch the hook 28, or alternatively the relationship between the hook 28 and the hole 19 can be inverted in vertical position, that is, it is possible to arrange the hook on the upper casing 1, and the hole 19 in the lower casing 2.

As described hereinabove, if the configuration of each of the above embodiments is adopted, the upper and lower casings 1 and 2 can be secured to each other at corner portions formed with the respective openings 12 and 22 for allowing a tape to be extracted, which makes it possible to enhance the strength of the above corner portions, resulting in the sufficiently increased reliability of the tape cartridge.

(Third Embodiment)

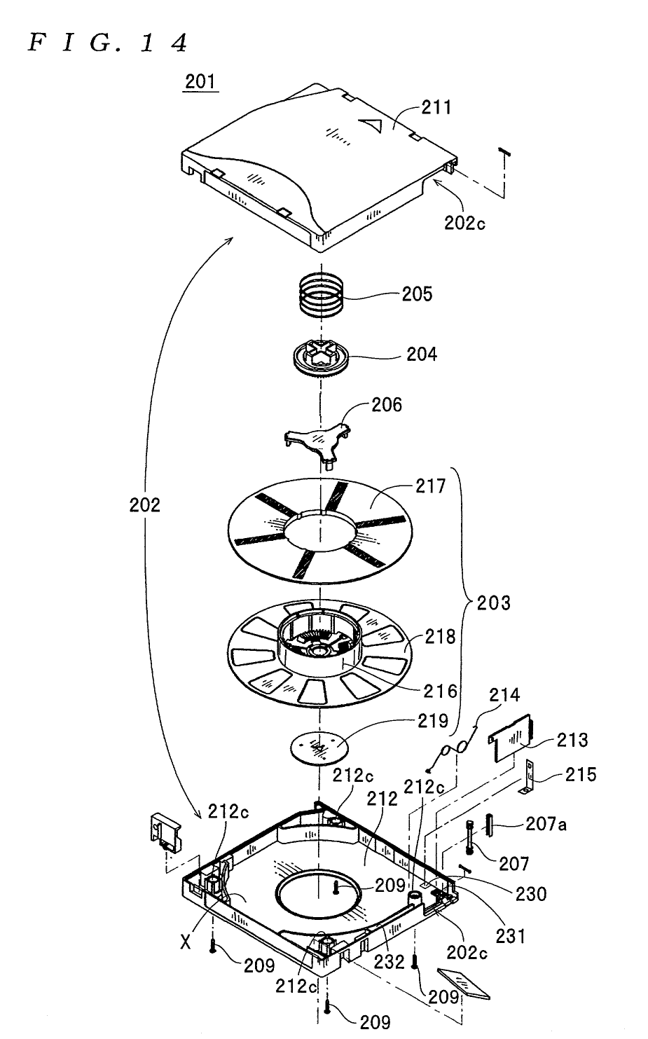

First, the construction of a tape cartridge 201 will be described with reference to FIGS. 14 to 25.

The tape cartridge 201 is a single-reel cartridge type recording medium which is used e.g. as a backup medium for preserving data recorded in a main recording medium for a computer, and as shown in FIG. 14, is comprised of a casing body (cartridge body) 202, a tape reel 203, a lock member 204, a spring 205, a brake release plate 206, and a pin member 207. It should be noted that the tape reel 203 is wound with a magnetic tape but the magnetic tape is not shown in the figures for clarity of the arrangement of the above component parts. Further, similarly to the case of the tape cartridge shown in FIG. 1, the leading end of the magnetic tape is wound around the pin member 207 and fixed by a stopper 207a.

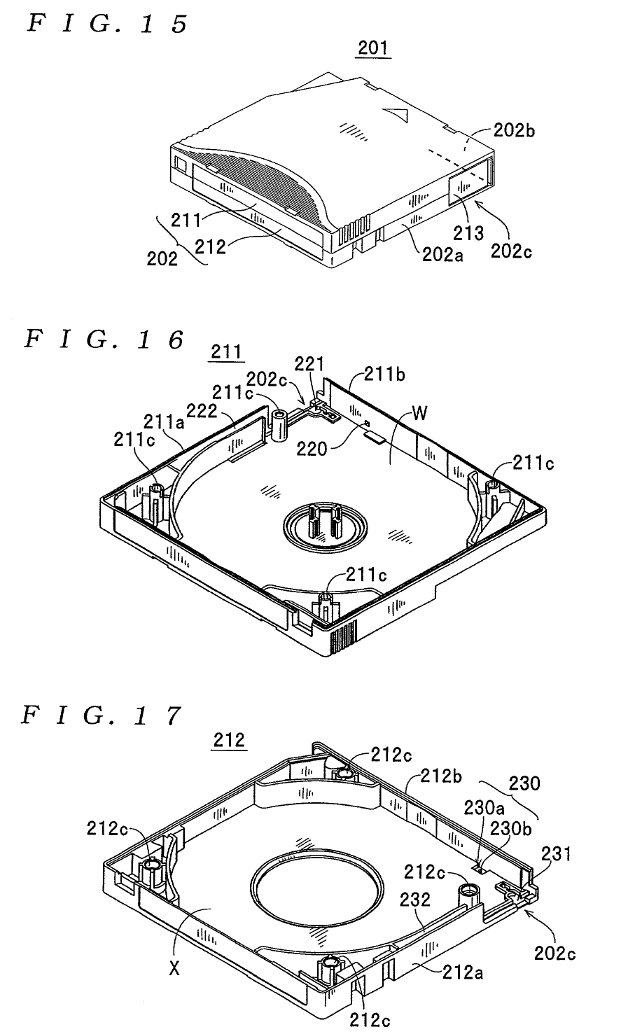

Referring to FIG. 14, the casing body 202 is comprised of a pair of an upper casing (the other cartridge half) 211 and a lower casing (one cartridge half) 212 which are shallow plate-shaped and can be combined with each other, a shutter member 213, a spring 214, and an engaging piece 215. Further, the casing body 202 is formed into the shape of a box by combining the upper casing 211 and the lower casing 212 with each other and fastening them with self-tapping screws 209 (see FIG. 15). Further, as shown in FIG. 15, out of four peripheral walls of the casing body 202, a side peripheral wall (one peripheral wall) 202a has a right-side corner portion formed with a tape extraction hole 202c which extends to a front peripheral wall (the other peripheral wall) 202b adjacent to the side peripheral wall 202a. In this embodiment, the tape extraction hole 202c is opened and closed by the shutter member 213.

Referring to FIG. 16, the upper casing 211 has a right corner portion of one side wall 211a forming part of the side peripheral wall 202a of the casing body 202, cut away into a rectangular shape so as to form the tape extraction hole 202c. Further, the upper casing 211 is formed with four screw bosses 211c, 211c, 211c and 211c for screwing the self-tapping screws 209 therein, such that they vertically extend from an inner surface of a main wall W of the upper casing 211. Three of the four screw bosses 211c, 211c, 211c and 211c are arranged at respective corner portions of the upper casing 211, while the other one is arranged at a location which is shifted from the corner portion formed with the tape extraction hole 202c toward the left-end side of the side wall 211a by the length of the cut-away portion so as to prevent the other one from interfering with the tape extraction hole 202c. Further, a side wall (second side wall) 211b of the upper casing 211 forming part of the front peripheral wall 202b of the casing body 202 has an engaging recess 220 formed in an inner surface portion thereof in the vicinity of the tape extraction hole 202c. Furthermore, the main wall W of the upper casing 211 has an inner surface formed with a concave holder portion 221 for receiving the pin member 207 therein, in the vicinity of the side wall 211b at a location facing the tape extraction hole 202c. Further, on an inner-surface side of the side wall 211a, there is formed a guide groove 222. Additionally, as shown in FIG. 20, each side wall of the upper casing 211 has an end surface formed into a stepped shape with an inner portion of the stepped end surface protrudes downward.

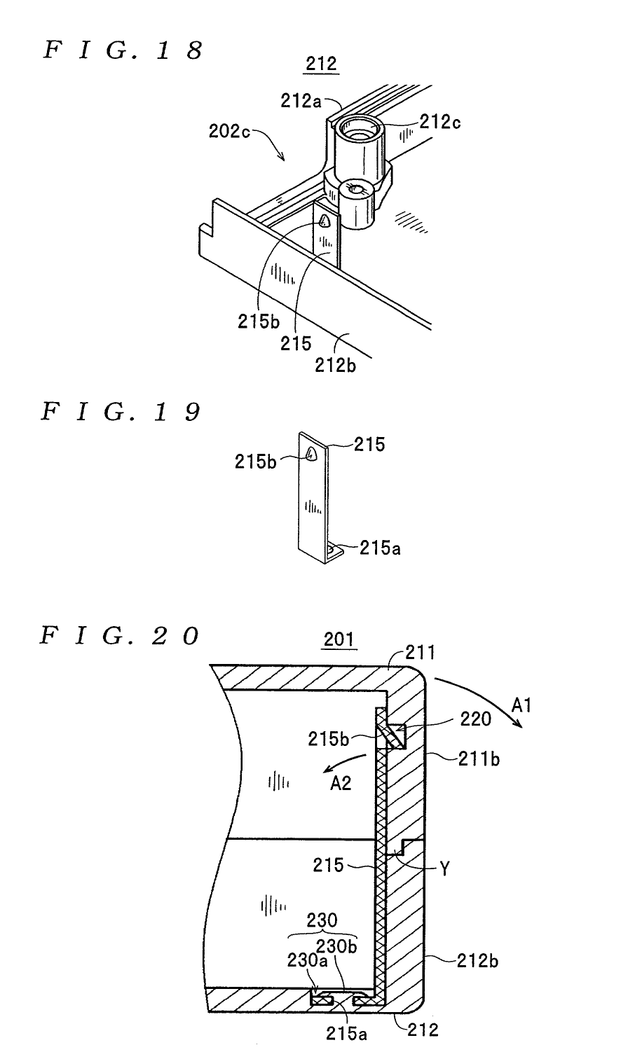

Referring to FIG. 17, the lower casing 212 has a right corner portion of a side wall 212a forming part of the side peripheral wall 202a of the casing body 202, cut away into a rectangular shape so as to form the tape extraction hole 202c. Further, the lower casing 212 is formed with four screw holes 212c, 212c, 212c and 212c for inserting the self-tapping screws 209, such that they are arranged at respective locations in an inner surface of a main wall X of the lower casing 212 opposed to the respective screw bosses 211c, 211c, 211c, and 211c. Further, as shown in FIG. 18, a side wall (first side wall) 212b of the lower casing 212, which forms part of the front peripheral wall 202b of the casing body 202, has an engaging piece 215 arranged on an inner surface side thereof in the vicinity of the tape extraction hole 202c. The engaging piece 215 has one end (lower end) rigidly fixed to the lower casing 212, and the other end (upper end) extending upright toward the upper casing 211. More specifically, as shown in FIG. 17, a fixing portion 230 for having the one end of the engaging piece 215 fixed thereat is formed at a location in the inner surface of the main wall X of the lower casing 212 opposed to the engaging recess 220 of the upper casing 211. This fixing portion 230 is formed, for instance, in the inner surface of the main wall X, and is formed by arranging a boss 230b on a bottom surface of a concave portion 230a which is capable of holding the one end of the engaging piece 215, such that the boss 230b protrudes from the bottom surface of the concave portion 230a.

On the other hand, as shown in FIG. 19, the engaging piece 215 is formed into an L shape by bending an elastic thin metal plate material at a portion on the one-end side thereof at right angles. Further, the engaging piece 215 has the one-end side portion thereof formed with a fixing hole 215a, and the other-end side portion thereof formed with a hook portion 215b. As shown in FIG. 20, this engaging piece 215 has a surface from which the hook portion 215b protrudes brought into contact with the side wall 212b of the lower casing 212, and at the same time is rigidly fixed to the lower casing 212 by fitting one end thereof in the concave portion 230a of the lower casing 212 and fusing the boss 230b inserted into the fixing hole 215a to close the fixing hole 215a. Further, as shown in FIG. 17, at a portion of an inner surface of the lower casing 212, facing the tape extraction hole 202c, a concave holder portion 231 for receiving the pin member 207 therein is formed in the vicinity of the side wall 212b. Further, a guide groove 232 is formed in an inner-surface side of the side wall 212a of the lower casing 212. Furthermore, as shown in FIG. 20, each side wall of the lower casing 212 has an end surface formed into a stepped shape with an outer portion of the stepped end surface protruding upward.

Referring to FIG. 14, the tape reel 203 is comprised of a hub 216, a pair of flanges (upper flange 217 and a lower flange 218), and a metal plate 219. The hub 216 is formed into a bottomed cylindrical shape around which a magnetic tape can be wound, and integrally formed with the lower flange 218. The upper flange 217 is secured to the top of the hub 216 by ultrasonic welding, while the metal plate 219 is rigidly fixed to an outer bottom surface of the hub 216.

Next, a procedure for assembling the tape cartridge 201 will be described with reference to FIG. 14. First, the engaging piece 215 is rigidly fixed to the lower casing 212, and the tape reel 203 is placed on the inner surface of the main wall X of the lower casing 212. At this time, a magnetic tape is not mounted on the tape reel 203. Then, the brake release plate 206, the lock member 204, and the spring 205 are sequentially placed on the inner bottom surface of the hub 216 of the tape reel 203. Next, the spring 214 and the shutter member 213 are fitted in the guide groove 232 of the lower casing 212. Thereafter, the upper casing 211 is placed on the lower casing 212 to combine the upper casing 211 with the lower casing 212 (fit the upper casing 211 on the lower casing 212). When the upper casing 211 is fitted on the lower casing 212, the upper portion of the shutter member 213, which protrudes from the guide groove 232, enters the guide groove 222 of the upper casing 211, and further, as shown in FIG. 20, the hook portion 215b of the engaging piece 215 enters the engaging recess 220 of the upper casing 211 for engagement therewith. Further, as shown in the same figure, the stepped end surfaces of the respective side walls 211b and 212b of the upper casing 211 and the lower casing 212 are fitted on each other in a recess/projection form with no gap therebetween. Next, as shown in FIG. 14, the self-tapping screws 209 are inserted into the respective screw holes 212c, 212c, 212c and 212c of the lower casing 212 for screwing the same into the screw bosses 211c, 211c, 211c, and 211c of the upper casing 211, whereby the upper casing 211 and the lower casing 212 are fastened to each other. Then, the casing body 202 is mounted on a winder for winding a magnetic tape around the tape reel 203. Finally, after fixing the pin member 207 to a leading end of the magnetic tape, the magnetic tape is further wound, and the pin member 207 is fitted in the holder portions 221 and 231, thus completing the tape cartridge 201.

In an assembled state, the shutter member 213 is held between the guide groove 232 and the guide groove 222 in a manner irremovable from the casing body 202, and at the same time slidable along the side peripheral wall 202a between a closing position for closing the tape extraction hole 202c and an opening position for opening the same. Similarly, the spring 214 as well is held between the guide groove 232 and the guide groove 222 in a manner irremovable from the casing body 202 so as to always urge the shutter member 213 in a direction of the tape extraction hole-closing position. Further, the pin member 207 is held between the holder portion 221 of the upper casing 211 and the holding portion 231 of the lower casing 231. Furthermore, as shown in FIG. 20, the side wall 211b of the upper casing 211 and the side wall 212b of the lower casing 212 are connected to each other by the engaging piece 215 at respective end portions thereof at a location toward the tape extraction hole 202c whereby the movement of the side walls 211b, 212b in a direction away from each other is restricted. The side wall 211b of the upper casing 211 and the side wall 212b of the lower casing 212 have the respective stepped end surfaces thereof fitted on each other in a recess/projection form, whereby it is possible to prevent the outward movement and deformation of the side wall 211b with respect to the side wall 212b as well as the inward movement and deformation of the side wall 212b with respect to the side wall 211b. As a result, it is possible to prevent mutual separation of the hook portion 215b of the engaging piece 215 and the engaging recess 220 from each other. Therefore, the side wall 211b is connected to the side wall 212b in a state in which the movement (upward movement) of the end surface of the side wall 211b in a direction away from the end surface of the side wall 212b, and the movements of the side wall 211b toward the outside and inside surfaces thereof (outward and inward movement thereof with respect to the side wall 212b) are restricted.

On the other hand, if the casing body 202 is deformed or damaged due to some cause, there is a case in which only the tape reel 203 wound with a roll of a magnetic tape is taken out from the casing body 202, and mounted in another new casing body 202 for use. In such a case, the tape cartridge 201 is required to be disassembled. In disassembly, first, the self-tapping screws 209 are removed, and then on the side of a peripheral wall opposed to the front peripheral wall 202b, the upper and lower casings 211 and 212 are rotated for mutual separation by taking the front peripheral wall 202b side as a fulcrum. In doing this, as shown in FIG. 20, the upper casing 211 is rotated in a direction indicated by an arrow A1 in the figure. When the upper casing 211 is rotated, since the inner portion of the stepped end surface of the side wall 211b protrudes, the protruding portion Y elastically deforms the engaging piece 215 toward the inside of the casing body 202 according to the principles of the lever and fulcrum. Hence, the engaging piece 215 is elastically deformed about the fixing portion 230 in a direction indicated by an arrow A2 in the figure, and the hook portion 215b as well is moved in the direction indicated by the arrow A2, so that the engaging or retaining relation between the hook portion 215b and the engaging recess 220 is canceled. This enables the tape cartridge 201 to be disassembled with ease.

As described above, according to the tape cartridge 201, the end surface of the side wall 211b of the upper casing 211 and the end surface of the side wall 212b of the lower casing 212 are fitted on each other in the recess/protrusion form, whereby it is possible to prevent a mutual separation of the hook portion 215b of the engaging piece 215 and the engaging recess 220. This makes it possible to reliably reinforce a corner portion of the casing body 202, which is formed by the side peripheral wall 202a and the front peripheral wall 202b, and which due to provision of the tape extraction hole 202c, is generally reduced in rigidity in comparison with the other corner portions. Therefore, even when a shock or impact is caused by a fall or the like of the tape cartridge 202, a mutual separation of the portions of the upper casing 211 and the lower casing 212 formed with the tape extraction hole 202c can be prevented, so that it is also possible to reliably prevent disengagement of the pin member 207 from the holding portions 221 and 231. This makes it possible to provide the tape cartridge 201 which having an enhanced reliability which ensures that a magnetic tape can be positively drawn out. Further, since the engaging piece 215 is made of a thin metal plate material, it is possible to increase the space of the portion of the tape cartridge 201 formed with the tape extraction hole 202c, which makes it possible to smoothly draw out the magnetic tape from the tape extraction hole 202c.

(Fourth Embodiment)

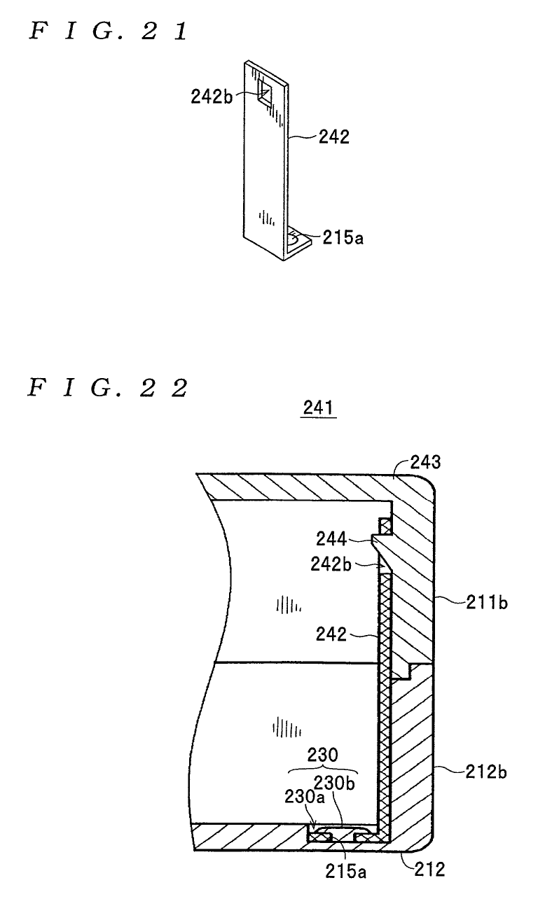

It should be noted that the present invention is not limited to the above embodiments, but the construction thereof can be modified as required. For instance, although in the third embodiment, description was given based on the example of the tape cartridge 201 in which the convex hook portion 215b is formed on the other end of the engaging piece 215, and the engaging recess 220 for engaging the engaging piece 215 is formed in the side wall 211b of the upper casing 211, thereby preventing a mutual separation of the side wall 211b of the upper casing 211 and the side wall 212b of the lower casing 212, this is not limitative, but it is also possible to employ an engaging piece 242 shown in FIG. 21. This engaging piece 242 is constructed, similarly to the engaging piece 215, by bending one end of a thin metal plate material, forming a fixing hole 215a in the bent end, and forming an engaging hole 242b in the other end. On the other hand, as shown in FIG. 22, a tape cartridge 241 including the engaging piece 242, according to the fourth embodiment of the invention, has an engaging projection 244 formed on an inner surface of a side wall 211b of an upper casing 243 such that the engaging projection 244 can be engaged in the engaging hole 242b. This tape cartridge 241 as well is capable of preventing a mutual separation of the side wall 211b of the upper casing 243 and the side wall 212b of the lower casing 212, so that it is possible to provide the same advantageous effects as provided by the tape cartridge 201. Moreover, if the tape cartridge 201 (or similarly the tape cartridge 241) has a protruding portion formed on an end surface of one of the side wall 211b of the upper casing 243 and the side wall 212b of the lower casing 212, and a recessed portion formed in an end surface of the other of the side wall 211b and the side wall 212b, it is also possible to fit the casings 211 and 212 in a recess/protrusion form.

(Fifth Embodiment)

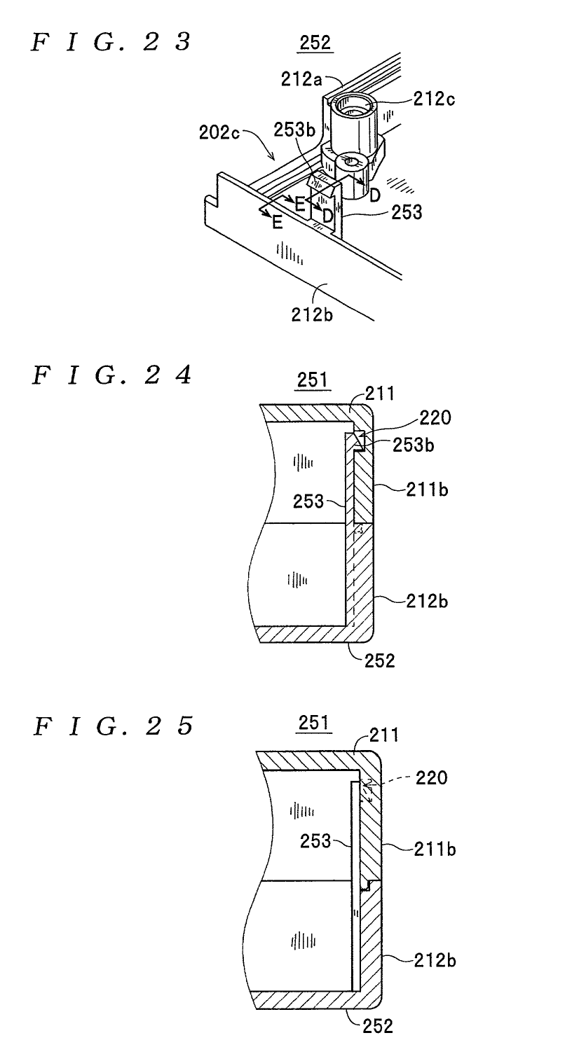

Although in the third embodiment, description was given based on the example of the tape cartridge 201 including the engaging piece 215 which is formed of a metal plate material as a separate member from the lower casing 212, this is not limitative, but as shown in FIG. 23, it is also possible to adopt a configuration in which a lower casing 252 is resin-molded integrally with an engaging piece 253 which extends upward from an inner portion of a side wall 212b of the lower casing 252 with an upper end thereof formed with a hook portion 253b. As shown in FIG. 24, in a tape cartridge 251 which adopts the above configuration, according to the fifth embodiment of the invention, a portion (extending portion, portion corresponding to the lateral width of the engaging piece 253) of the end surface of the side wall 212b from which the engaging piece extends upward, and an end surface portion of the side wall 211b of the upper casing 211 brought into contact with the extending portion are formed into flat surfaces in view of the structure of a mold for molding the lower casing 252. On the other hand, as shown in FIG. 25, end surfaces of the side walls 211b and 212b other than those of the extending portion and the portion in contact with the extending portion, are formed into stepped shapes, similarly to the end surfaces of the tape cartridge 201, whereby the movement and deformation of the side wall 211b (or side wall 212b) with respect to the side wall 212b (or side wall 211b) are restricted. According to this configuration, the number of component parts of the tape cartridge 251 can be reduced, and it is possible to omit an assembling process for assembling the engaging piece 253 to the lower casing 252, thereby making it possible to reduce manufacturing costs of the tape cartridge.

(Sixth Embodiment)

Further, the configuration described as the first embodiment, in which the side wall 1b of the upper casing 1 and the side wall 2b of the lower casing 2 are welded to each other by the welding rib 24, can be combined with the configuration described as to the fifth embodiment, in which the end surface of the side wall 211b of the upper casing 211 and that of the side wall 212b of the lower casing 252 are fitted on each other in the recess/projection form, and at the same time the engaging piece 253 is extended along the inner surface of the side wall 211b, thereby preventing a mutual separation of the side wall 211b and the side wall 212b.

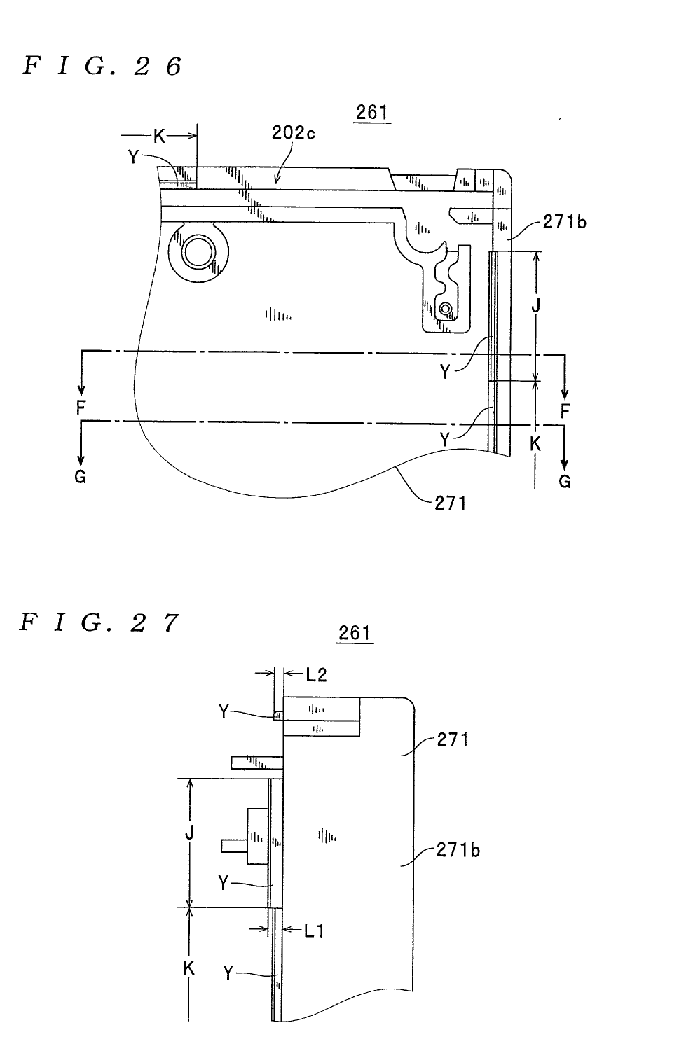

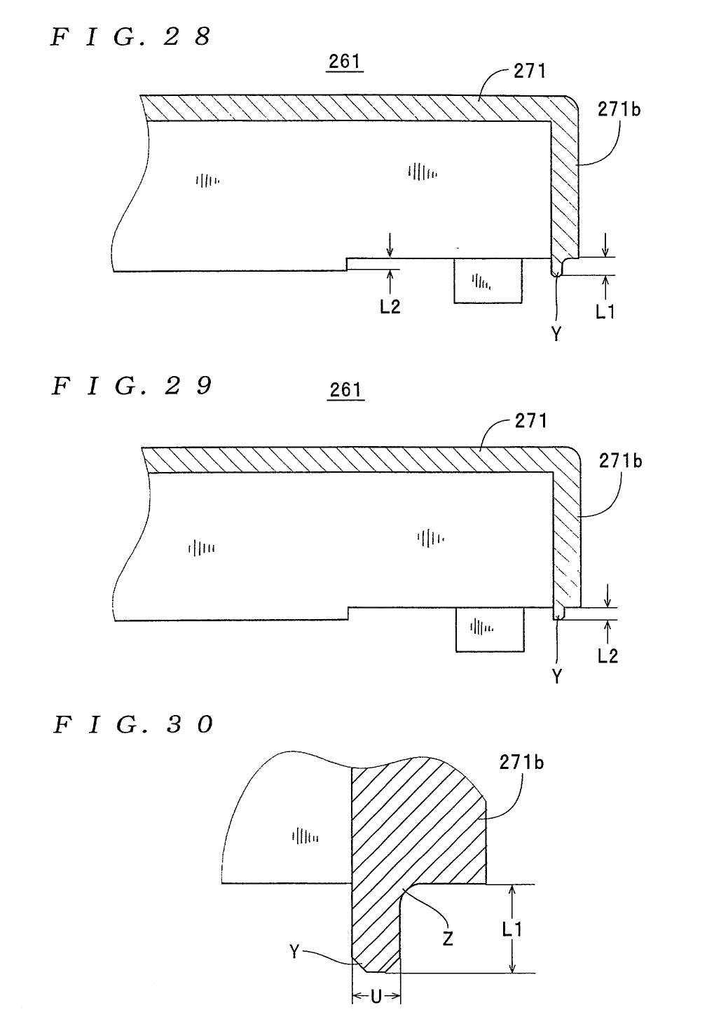

In a tape cartridge 261 according to the sixth embodiment of the invention, which adopts the above combined configuration, each side wall of an upper casing 271 has an end surface formed into a stepped shape in which an inner portion of the end surface protrudes, as shown in FIGS. 26 and 27. In this case, the side wall 271b of the upper casing 271, which forms part of the front peripheral wall of the casing body, has a protruding portion Y formed in an area J close to the tape extraction hole 202c. The protruding portion Y is set such that it has a length L1 (see FIG. 28) larger than a length L2 (see FIG. 29) of a protruding portion Y formed in the other area K. An end portion (having a length equal to the difference between L1 and L2) of the protruding portion Y in the area J serves as a welding rib. Further, as shown in FIG. 30, the protruding portion Y formed in the area J is set such that a width U thereof is progressively increased at a root portion Z toward an outer surface side of the side wall 271b, and the root portion Z of the protruding portion Y in the area J is brought into contact with a corner portion, referred to hereinafter, so as to serve as a welding portion. Further, the corners of the end of the protruding portion Y in each of the areas J and K are chamfered to form a U shape in cross section. This facilitates fitting of the side wall 271b of the upper casing 271 and the side wall 272b of the lower casing 272 to each other.

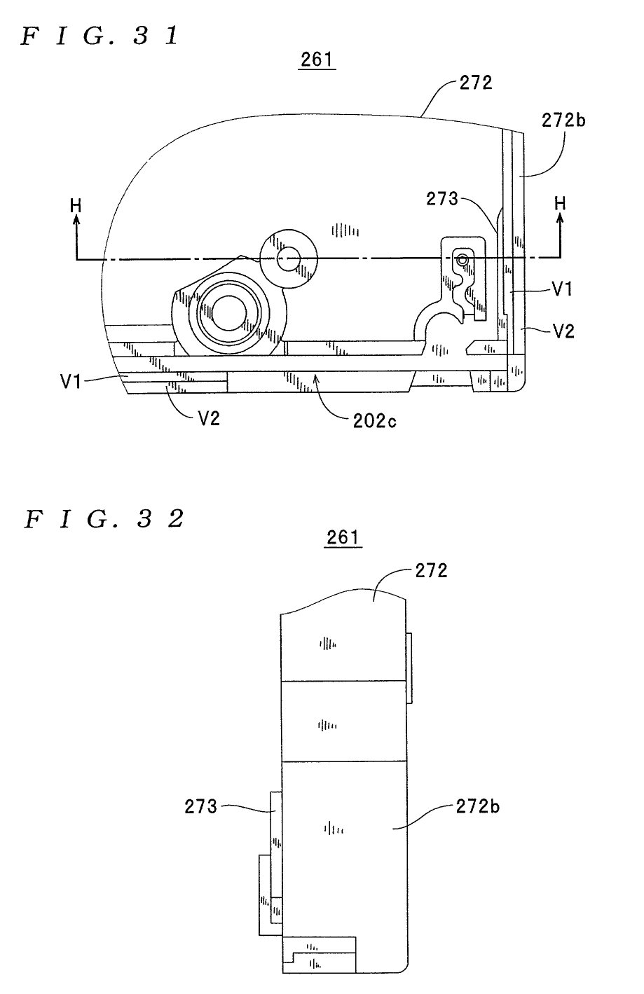

On the other hand, as shown in FIGS. 31 to 33, each side wall of the lower casing 272 has an end surface formed into a stepped shape in which a recess V1 is formed in an inner portion of the end surface such that it extends along the side wall. In this example, as shown in FIG. 33, the depth L3 of the recess V1 is set to an identical depth (identical to the length L2 of the protruding portion Y in the area K of the upper casing 271) along the whole of each side wall of the lower casing 272. However, there is no need to set the depth of the whole recess V1 to an identical depth. It is only required to set the depth L3 of the recess V1 to a depth corresponding to the length of the protruding portion Y in the area K of the upper casing 271. More specifically, it is only required to set the depth L3 at an arbitrary portion of the recess V1 and the length L2 of the corresponding protruding portion Y such that the upper and lower casings can be fitted on each other in the recess/projection form. Further, a remaining portion V2 which is formed on the end surface of each side wall in a manner protruding relative to the recess V1, has its corner portion (the aforementioned corner portion) formed at an approximately right angles. Further, the side wall 272b of the lower casing 272, which forms part of the front peripheral wall of the casing body, has an engaging piece 273 in the form of a flat plate integrally formed therewith by resin molding, in the vicinity of the tape extraction hole 202c. In this case, the engaging piece 273 is erected (toward the side wall 271b) from an inner portion of the side wall 272b, and at the same time an upper end portion thereof is arranged such that it faces an inner wall surface of the side wall 271b.

Next, out of a procedure for assembling the tape cartridge 261, especially, a coupling procedure for coupling the upper casing 271 and the lower casing 272 together will be described hereinafter. First, the upper casing 271 is placed on the lower casing 272 to combine the upper casing 271 with the lower casing 272 (fit the upper casing 271 on the lower casing 272). When the upper casing 271 is fitted on the lower casing 272, the protruding portion Y formed on the end surface of each side wall 271b of the upper casing 271 enters the recess V1 formed in the end surface of each side wall 272b of the lower casing 272, whereby the end surfaces of the respective side walls 271b and 272b of the upper casing 271 and the lower casing 272 which are each formed into a stepped shape are fitted on each other in the recess/projection form. When the end surfaces are fitted, the protruding portion Y having the length L1 and formed in the area J in the side wall 271b is brought into contact with a bottom surface of the recess V1 (depth L3) in the side wall 272b, but a gap equal to the difference between L1 and L2 (also equal to a difference between L1 and L3) is formed to thereby lift the upper casing 271. More specifically, the end surfaces of the respective side walls of the upper casing 271 and the lower casing 272 are not brought into close contact with each other.

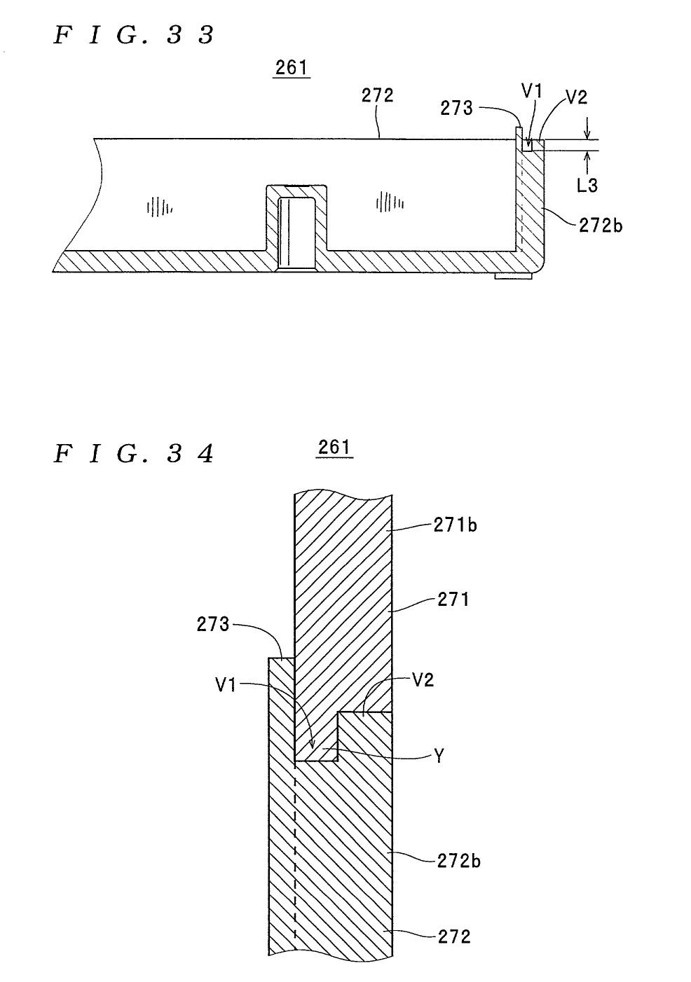

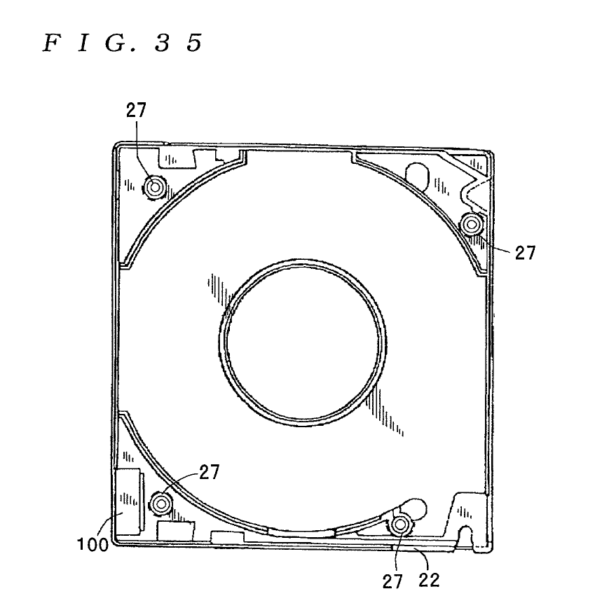

Next, ultrasonic waves are applied only to a portion of each of the side walls 271b and 272b close to the tape extraction hole 202c, whereby the end of the protruding portion Y in the area J in the side wall 271b is integrally fused with the bottom surface of the recess V1 in the side wall 272b abutting the end of the protruding portion Y. At the same time, the root portion Z of the protruding portion Y in the area J is integrally fused with the corner portion abutting the root portion Z, on the inner surface side of the portion V2 of the side wall 272b. In this case, the engaging piece 273 prevents movement of the side wall 271b toward the engaging piece 273 side (toward the inside of the tape cartridge 261), and prevents a squeezed portion of a resin melted by application of ultrasonic waves or scrapings produced by vibration from entering the inside of the tape cartridge 261 to thereby scratch or adhere to the surface of a magnetic tape. As described above, the end surfaces of the respective side walls 271b and 272b of the upper casing 271 and the lower casing 272, which are each formed into a stepped shape, are partially welded to each other, whereby as shown in FIG. 34, the side walls 271b and 272b can be fitted on each other in the recess/protrusion form with no gap therebetween. It should be noted that it is not necessarily required that the root portion Z is welded to the corner portion on the inner surface side of the portion V2 of the side wall 272b. Even if the tape cartridge is configured such that the root portion Z is formed at right angles to the end surface of the side wall 271b to weld only the end of the protruding portion Y and the bottom surface of the recess V1 to each other, it is possible to reliably fit the side walls 271b and 272b on each other in the recess/protrusion form with no gap therebetween.

In an assembled state, as shown in FIG. 34, since the protruding portion Y and the recess V1 are secured to each other by welding, the side wall 271b of the upper casing 271 and the side wall 272b of the lower casing 272 are restricted from moving in a direction of mutual separation. Further, the side walls 271b and 272b are fitted on each other in the recess/projection form with the protruding portion Y of the side wall 271b being held between the engaging piece 273 and the portion V2 of the side wall 272b, whereby it is possible to prevent the inward and outward movement and deformation of the side wall 271b with respect to the side wall 272b as well as prevent the inward and outward movement and deformation of the side wall 272b with respect to the side wall 271b.

What is claimed is:

1. A tape cartridge including a cartridge body which has a pair of cartridge halves combined with each other to form a shape of a box, the pair of cartridge halves having side walls forming peripheral walls of the cartridge body, and a tape reel received within the cartridge body with a roll of a tape wound therearound, the tape cartridge being configured such that a tape extraction hole is formed in a corner portion of one of the peripheral walls of the cartridge body, and that a first side wall of one of the cartridge halves and a second side wall of another of the cartridge halves forming another of the peripheral walls adjacent to the corner portion have respective end surfaces thereof brought into contact with each other,
characterized in that the second side wall is coupled to the first side wall in a state in which movement of the end surface of the second side wall in a direction away from the end surface of the first side wall and respective movements of the second side wall toward an outer surface side and an inner surface side thereof are restricted.

2. A tape cartridge according to claim 1, including an engaging piece which is arranged on an inner surface side of a portion of the another of the peripheral walls, the portion being close to the tape extraction hole, with one end thereof being rigidly fixed to the one of the cartridge halves, and at the same time with another end thereof extending toward the another of the cartridge halves for engagement with the second side wall, and
wherein the second side wall is restricted from moving toward the outer surface side thereof by the first side wall.

3. A tape cartridge according to claim 2, wherein the end surface of the first side wall is formed into a stepped shape in which an outer portion thereof protrudes, the end surface of the second side wall being formed into a stepped shape in which an inner portion thereof protrudes.

4. A tape cartridge according to claim 2, wherein the engaging piece is formed of a metal plate material.

5. A tape cartridge according to claim 3, wherein the engaging piece is formed of a metal plate material.

6. A tape cartridge according to claim 2, wherein the engaging piece is integrally formed with the one of the cartridge halves by resin molding.

7. A tape cartridge according to claim 3, wherein the engaging piece is integrally formed with the one of the cartridge halves by resin molding.

8. A tape cartridge according to claim 1, wherein the first side wall and the second side wall are coupled to each other by being secured by welding at least respective portions of the end surfaces thereof in the vicinity of the tape extraction hole.

9. A tape cartridge according to claim 2, wherein the first side wall and the second side wall are coupled to each other by being secured by welding at least respective portions of the end surfaces thereof in the vicinity of the tape extraction hole.

10. A tape cartridge according to claim 3, wherein the first side wall and the second side wall are coupled to each other by being secured by welding at least respective portions of the end surfaces thereof in the vicinity of the tape extraction hole.

11. A tape cartridge according to claim 1, including an engaging piece which is located on the inner surface side of the another of the peripheral walls in the vicinity of the tape extraction hole, and erected from the first side wall along an inner wall surface of the second side wall, and
the end surface of the first side wall being formed into a stepped shape in which an outer portion thereof protrudes,
the end surface of the second side wall being formed into a stepped shape in which an inner portion thereof protrudes,
the first side wall and the second side wall being coupled to each other by being secured by welding at least respective portions of the end surfaces thereof in the vicinity of the tape extraction hole.

12. A tape cartridge including a cartridge body formed by a pair of square cartridge halves, and a tape reel rotatably received within the cartridge body, with a roll of a tape wound therearound, wherein a memory element is provided in a corner portion of the cartridge body outside a tape reel area thereof, one corner portion of the cartridge body other than the corner portion having the memory element provided therein being formed with a tape extraction hole for allowing the tape to be extracted out of the cartridge body,
characterized in that the pair of cartridge halves are fastened by screws outside the tape reel area, and at the same time the one corner portion formed with the tape extraction hole is fastened by a method other than screwing.

13. A tape cartridge according to claim 12, wherein the corner portion formed with the tape extraction hole is secured by welding.

14. A tape cartridge according to claim 12, wherein the corner portion formed with the tape extraction hole is secured by a hook formed in the one of the cartridge halves and a recess formed in the another of the cartridge halves in a manner corresponding to the hook.
